(19) United States
(12) Patent Application Publication
(10) Pub. No.: US 2009/0147827 A1
(43) Pub. Date: Jun. 11, 2009

(54) Methods, Systems, and Computer Program Products for Implementing Spread Spectrum Using Digital Signal Processing Techniques

(76) Inventors: Richard Holmquist, Rochester, MN (US); Jordan R. Keuseman, Rochester, MN (US); David R. Motschman, Rochester, MN (US); George R. Zettles, IV, Rochester, MN (US)

Correspondence Address: CANTOR COLBURN LLP - IBM ROCHESTER DIVISION, 20 Church Street, 22nd Floor, Hartford, CT, 06103, US

(21) Appl. No.: 11/951,726

(22) Filed: Dec. 6, 2007

(51) Int. Cl. H04B 1/69

(52) U.S. Cl. 375/130; 375/373; 375/E01.001

(57) ABSTRACT

Implementing spread spectrum using digital signal processing techniques. An incoming clock signal is received and sampled using a programmable sampling mechanism to generate a plurality of signal data points included in a sampled signal. The sampled signal is conditioned using a programmable signal conditioning mechanism capable of performing at least one of: reducing a cycle to cycle jitter of the sampled signal; or adjusting the sampled signal to a base frequency. The signal data points are processed and spread across a band of frequencies using a programmable digital signal processor to adjust at least one of: (a) an amplitude, (b) a phase shift, or (c) a frequency shift; for each of a plurality of respective signal data points at a plurality of corresponding frequencies in the band of frequencies. An output waveform is constructed from the processed and spread signal data points, wherein the output waveform constitutes a clock output signal.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to techniques for reducing or minimizing radio frequency interference and, more particularly, to methods, systems, and computer program products for implementing spread spectrum using digital signal processing techniques.

2. Description of Background

A conventional radio frequency signal, such as that provided by a typical computer system clock or radio broadcasting station, has a center frequency which remains substantially constant over time, with the possible exception of small, rapid fluctuations that occur as a result of modulation. For example, when one listens to a radio signal at 103.3 MHz on an FM stereo receiver, the signal remains substantially centered at 103.3 MHz. This broadcast signal does not go up in frequency to 105.7 MHz or down to 99.1 MHz as a function of time. Similarly, in the case of a conventional computing system, a clock signal generated from a crystal reference oscillator remains at a constant frequency such as 300 MHz or 1.6 GHz, for example. In practice, the center frequency of a conventional clock signal or radio broadcast is kept as constant as state of the art technology will permit.

Electromagnetic interference (EMI) standards have been developed by the governing bodies of most industrialized nations. These standards were developed to allow devices that use a specific frequency or range of frequencies to operate without experiencing interference from other devices. There is currently no worldwide standard governing EMI. If a device fails to meet the EMI standards of a particular country, sale of the device in that country would most likely not be permitted. The standards specify a maximum allowable radiated radio frequency (RF) field strength that must not be exceeded at a specified distance from a device under test. As a practical matter, computing systems that use fixed-frequency clock signals may have difficulty meeting applicable EMI standards because all of the RF energy from the clock is concentrated at a single frequency.

Spread spectrum is a technique for distributing radio frequency energy across a wide bandwidth encompassing a multiplicity of individual frequencies. This distribution is performed in accordance with one or more specified mathematical functions. Some spread-spectrum signals use a digital scheme called frequency hopping wherein the frequency of the signal changes abruptly, many times each second. Between “hops,” the frequency remains stable. The length of time that the signal remains on a given frequency between “hops” is known as the dwell time. The minimum permissible frequency spacing between any two individual frequencies defines the granularity of a given spread spectrum scheme. Other spread-spectrum circuits employ continuous frequency variation, which is an analog-based scheme.

Spread spectrum has been used in conjunction with computing systems, such as supercomputers, to help ensure compliance with applicable EMI standards. Spread spectrum allows a computer designer to distribute the RF energy of a clock signal across a band of frequencies. The overall amount of RF energy radiated by a spread spectrum clocked computing system may not decrease relative to a system that uses a single clock frequency. However, spread spectrum is helpful in terms of reducing RF energy at one or more discrete frequencies, thereby enhancing the likelihood of achieving EMI compliance.

Existing spread spectrum techniques do not offer programmability or fine granularity. Consequently, it may be necessary to stock a plurality of different spread spectrum clocks, or a plurality of different integrated circuit chipsets, for each of a plurality of system applications. Moreover, as computing systems have moved into ever higher and higher frequency ranges, it has become increasingly more difficult to perform frequency spreading of a clock signal so as to achieve a desired level of granularity. If this desired level of granularity is not achieved, devices that are connected to the clock signal will not function properly. This loss in system functionality may lead to a total system failure. Although a spread spectrum clock could be replaced by a fixed frequency clock to restore system functionality, the computing system may now fail to meet applicable EMI standards.

In view of the foregoing considerations, improved techniques for generating a spread spectrum clock signal are needed. A solution that addresses, at least in part, the above and other shortcomings is desired.

### SUMMARY OF THE INVENTION

Embodiments of the invention include methods, systems, and computer program products for implementing spread spectrum using digital signal processing techniques. The methods include receiving an incoming clock signal. The incoming clock signal is sampled using a programmable sampling mechanism capable of sampling at three to five times the frequency of the incoming clock signal to generate a plurality of signal data points included in a sampled signal. The sampled signal is conditioned using a programmable signal conditioning mechanism capable of performing at least one of: reducing a cycle to cycle jitter of the sampled signal; or adjusting the sampled signal to a base frequency. The signal data points are processed and spread across a band of frequencies using a programmable digital signal processor to adjust at least one of: (a) an amplitude, (b) a phase shift, or (c) a frequency shift; for each of a plurality of respective signal data points at a plurality of corresponding frequencies in the band of frequencies. An output waveform is constructed from the processed and spread signal data points, wherein the output waveform constitutes a clock output signal.

The computer program products for implementing spread spectrum using digital signal processing techniques include a storage medium readable by a processing circuit and storing instructions for execution by the processing circuit for facilitating a method. The method includes receiving an incoming clock signal. The incoming clock signal is sampled using a programmable sampling mechanism capable of sampling at three to five times the frequency of the incoming clock signal to generate a plurality of signal data points included in a sampled signal. The sampled signal is conditioned using a programmable signal conditioning mechanism capable of performing at least one of: reducing a cycle to cycle jitter of the sampled signal; or adjusting the sampled signal to a base frequency. The signal data points are processed and spread across a band of frequencies using a programmable digital signal processor to adjust at least one of: (a) an amplitude, (b) a phase shift, or (c) a frequency shift; for each of a plurality of respective signal data points at a plurality of corresponding frequencies in the band of frequencies. An output waveform is constructed from the processed and spread signal data points, wherein the output waveform constitutes a clock output signal.

The systems for implementing spread spectrum using digital signal processing techniques include a programmable sampling mechanism for receiving an incoming clock signal, and for sampling the incoming clock signal at three to five times the frequency of the incoming clock signal to generate a plurality of signal data points included in a sampled signal. The programmable sampling mechanism is operatively coupled to a programmable signal conditioning mechanism for conditioning the sampled signal by performing at least one of: reducing a cycle to cycle jitter of the sampled signal; or adjusting the sampled signal to a base frequency. The programmable signal conditioning mechanism is operatively coupled to a programmable digital signal processor for processing the signal data points and spreading the signal data points across a band of frequencies by adjusting at least one of: (a) an amplitude, (b) a phase shift, or (c) a frequency shift; for each of a plurality of respective signal data points at a plurality of corresponding frequencies in the band of frequencies. The programmable digital signal processor is operatively coupled to a signal construction mechanism for constructing an output waveform from the processed and spread signal data points, wherein the output waveform constitutes a clock output signal.

Other methods, systems, and computer program products according to embodiments will be or become apparent to one with skill in the art upon review of the following drawings and detailed description. It is intended that all such additional methods and computer program products be included within this description, be within the scope of the present invention, and be protected by the accompanying claims.

### BRIEF DESCRIPTION OF THE DRAWINGS

Referring now to the drawings, wherein like elements are numbered alike in the several FIGURES:

FIG. 1 is a block diagram illustrating a prior art system for distributing a fixed frequency clock signal to a plurality of processors.

FIG. 2 is a block diagram illustrating a prior art system for distributing a spread spectrum clock signal to a plurality of processors.

FIG. 3 is a graph showing radiated RF power as a function of frequency for the fixed frequency system of FIG. 1.

FIG. 4 is a graph showing radiated RF power as a function of frequency for the spread spectrum system of FIG. 2.

FIG. 5 shows an illustrative prior art system for generating a spread spectrum clock signal.

FIG. 6 is a flowchart setting forth illustrative methods for generating a spread spectrum clock signal according to various exemplary embodiments of the invention disclosed herein.

FIG. 7 is a hardware block diagram setting forth an illustrative system for generating a spread spectrum clock signal according to various exemplary embodiments of the invention disclosed herein.

The detailed description explains the preferred embodiments of the invention, together with advantages and features, by way of example with reference to the drawings.

### DETAILED DESCRIPTION OF THE INVENTION

In the following description, details are set forth to provide an understanding of the invention. In some instances, certain software, circuits, structures and methods have not been described or shown in detail in order not to obscure the invention. The term “data processing system” is used herein to refer to any machine for processing data, including the client/server computer systems and network arrangements described herein. The present invention may be implemented in any computer programming language provided that the operating system of the data processing system provides the facilities that may support the requirements of the present invention. The invention may be implemented with software, firmware, or hardware, or any of various combinations thereof.

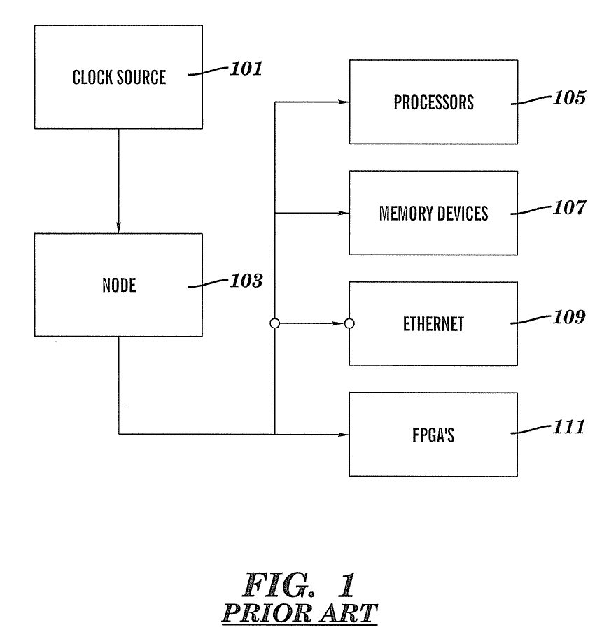

FIG. 1 is a block diagram illustrating a prior art system for distributing a fixed frequency clock signal to a plurality of processors. A clock source 101 is operatively coupled to a node 103. The node 103 is operatively coupled to various devices such as a plurality of processors 105, a plurality of memory devices 107, an Ethernet 109 interface, and field programmable gate arrays (FPGAs) 111. Illustratively, the processors 105 may represent a group of processor cards. The memory devices 107 may include random access memory (RAM), read-only memory (ROM), a data storage drive, a computer readable storage medium, or any of various combinations thereof. The FPGAs 111 represent integrated circuits that can be programmed in the field after manufacture. Essentially, the FPGAs 111 are similar to programmable ROM chips but are suited to a much wider range of applications than programmable ROM devices.

The clock source 101 is capable of producing a clock signal having sufficient output power to drive the processors 105 and the memory devices 107. In systems that use a number of processors 105 and memory devices 107, the clock source 101 may be called upon to generate a large amount of RF power. The processors 105 and the memory devices 107 are connected to the clock source 101 via interconnecting cables which may unintentionally radiate RF energy produced by the clock source 101. Likewise, the processors 105 and the memory devices 107 may themselves radiate RF energy received from the clock source 101. This radiated RF energy can be detected by an RF probe during electromagnetic compliance (EMC) testing. If the detected RF energy exceeds the EMI standards of the jurisdiction in which the system of FIG. 1 is to be marketed, the system must be redesigned to meet these EMC standards before it is sold. As a practical matter, EMC teams testing the system of FIG. 1 are likely to measure a large spike of power at the frequency of clock source 101. In some cases, this spike may be of sufficient magnitude to cause EMC noncompliance.

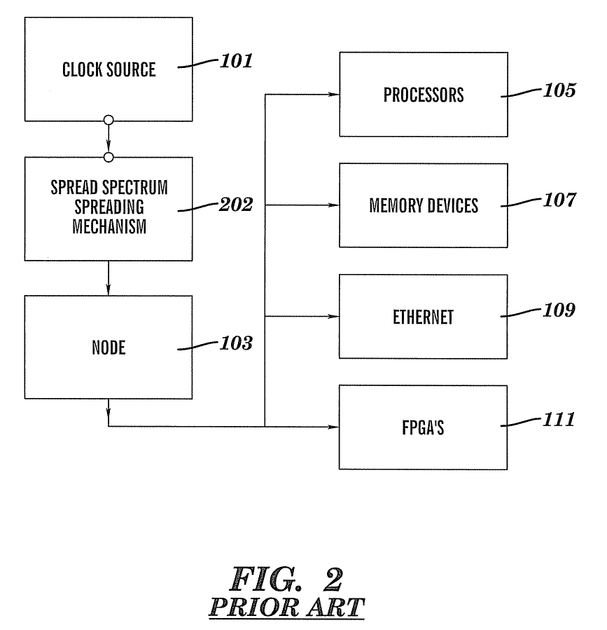

FIG. 2 is a block diagram illustrating a prior art system for distributing a spread spectrum clock signal to a plurality of processors. The spread spectrum clock signal is generated by placing a spread spectrum spreading mechanism 202 in series between the clock source 101 (FIGS. 1 and 2) and the node 103. The spread spectrum spreading mechanism 202 spreads the single frequency generated by the clock source 101 across a band of frequencies. The spreading mechanism 202 distributes the RF power generated by the clock source 101 among a plurality of different frequencies, such that the power is not all concentrated at one frequency.

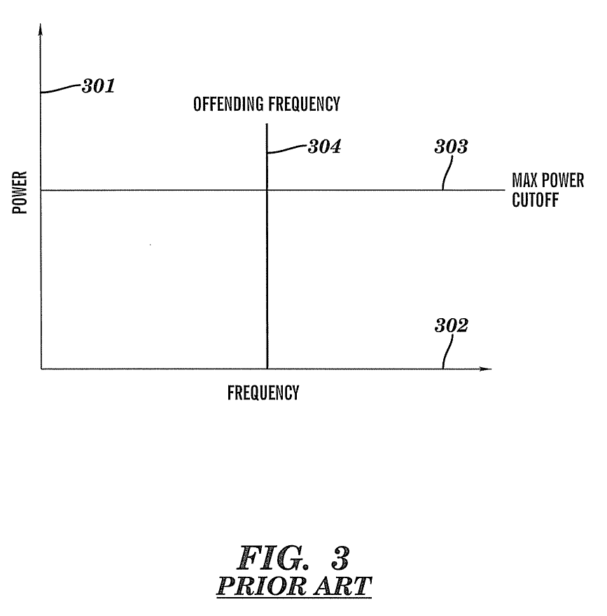

FIG. 3 is a graph showing radiated RF power 301 as a function of frequency 302 for the fixed frequency system of FIG. 1. The graph may be prepared, for example, by connecting an antenna or RF probe to the input of a spectrum analyzer and positioning the antenna or RF probe in proximity to the system of FIG. 1. In this manner, the antenna (or RF probe) and spectrum analyzer are used to detect and measure any RF radiation emanating from the system of FIG. 1. With reference to FIG. 3, a maximum power cutoff 303 represents the maximum permissible amount of radiated RF power according to the EMI standards of a jurisdiction under consideration. Observe that an offending frequency 304, representing the single frequency generated by the clock source 101 of FIG. 1, exceeds the maximum power cutoff 303. In this example, the graph of FIG. 3 reveals that the system of FIG. 1 fails to meet the EMI standards of the jurisdiction under consideration.

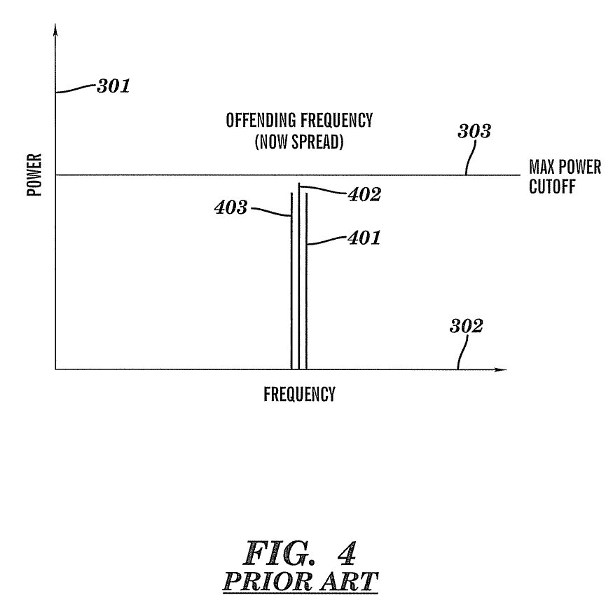

FIG. 4 is a graph showing radiated RF power 301 as a function of frequency 302 for the spread spectrum system of FIG. 2. Observe that the RF energy included in the offending frequency 304 of FIG. 3 is now distributed among a plurality of different frequency components in the graph of FIG. 4. These different frequency components include a first frequency component 401, a second frequency component 402, and a third frequency component 403. Three frequency components are shown for illustrative purposes, as a greater or lesser number of frequency components could, but need not, be provided in practice, so long as at least two frequency components are present. Illustratively, the second frequency component 402 may represent a base frequency (at the same frequency as offending frequency 304 of FIG. 3), with the first frequency component 401 (FIG. 4) at a higher frequency than the second frequency component 402 and the third frequency component 403 at a lower frequency than the second frequency component 402. The frequency difference between the first and second frequency components 401, 402, or the frequency difference between the third and second frequency components 403, 402, or both, may define an amount of spread applied to an incoming clock signal.

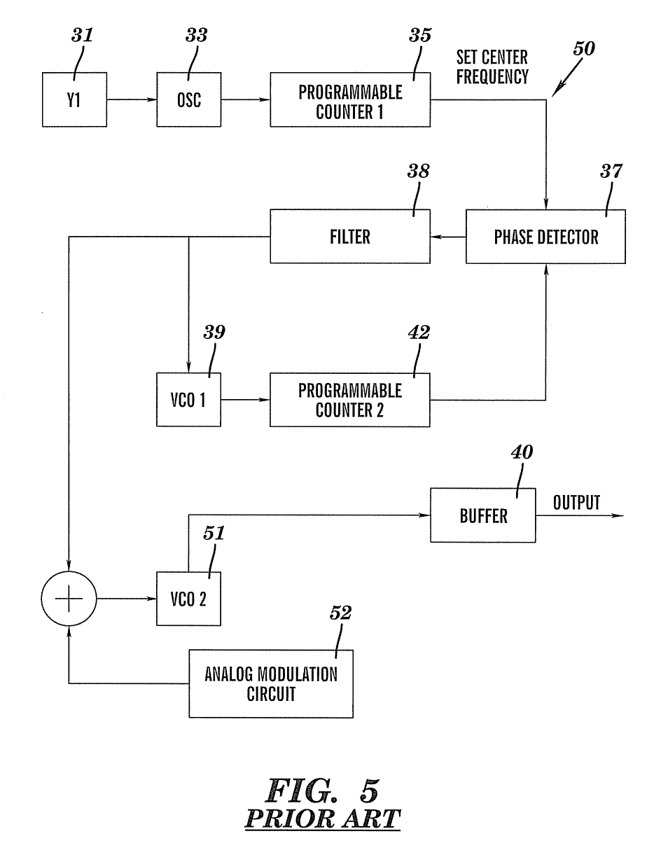

FIG. 5 illustrates a prior art implementation of a spread spectrum clocking mechanism 50. Y1 31 is a piezoelectric crystal used with an oscillator circuit 33 to generate a stable clock pulse train or unmodulated clock signal. A first programmable counter 35 divides the unmodulated clock signal by an integer number (M) and feeds the divided signal into a first input of a phase detector 37. A second programmable counter 42 divides the signal from a VCO 39 by an integer number (N). The phase detector 37 and filter 38 generate an analog signal that is proportional to the error in phase between first and second programmable counters 35, 42, respectively. Accordingly, the clock signal output from the buffer 40 is equal to the oscillator frequency times N/M. As would be readily understood by those skilled in the art, when N and M are constant, this circuit operates as a standard (PLL) circuit. The first and second programmable counters 35 and 42 are not used to provide a spread spectrum signal, but rather to provide a single frequency clock signal that is locked to the piezoelectric crystal Y1.

The spread spectrum is introduced by a second VCO 51 and an analog circuit 52. The second VCO 51 creates a clock signal identical to the first VCO 39 when no modulation is present. The second VCO 51 responds to the analog modulation to thereby create the spread spectrum clock output signal. Analog modulation circuit 52 may include an oscillator to generate the modulation frequency, an integrator to generate a triangle wave function (r(t)), a log anti-log amplifier (alog(3log(r(t)))), and an adder to generate a modulation profile of 0.55r(t)+0.45(alog(3log(r(t)))) Alternatively, the modulation may be added to the first VCO 39 input, as would be readily understood by those skilled in the art.

The prior art configuration of FIG. 5 is disadvantageous in that it is an analog circuit tuned to a specific use or system application. The first and second programmable counters 35, 42 are only capable of changing the frequency of a single-frequency clock signal that is locked to Y1, but these programmable counters have no effect on the manner in which this single frequency clock signal is subsequently spread by the analog modulation circuit 52. Accordingly, the configuration of FIG. 5 includes circuit elements (i.e., analog modulation circuit 52 and second VCO 51) that are useful for implementing a predetermined set of distributions of radio frequency energy across a bandwidth. Likewise, these circuit elements are useful for implementing a certain level of granularity. If a different system application requires a different distribution of radio frequency energy across a bandwidth, or a finer granularity, it may be necessary to redesign and produce a new integrated circuit to implement analog modulation circuit 52 and second VCO 51. Thus, if the configuration of FIG. 5. were to be used to implement several different spread spectrum systems with different requirements and objectives, a different integrated circuit chip would be required for each of these systems. A manufacturing enterprise offering these systems would have to maintain an inventory of each of these chips.

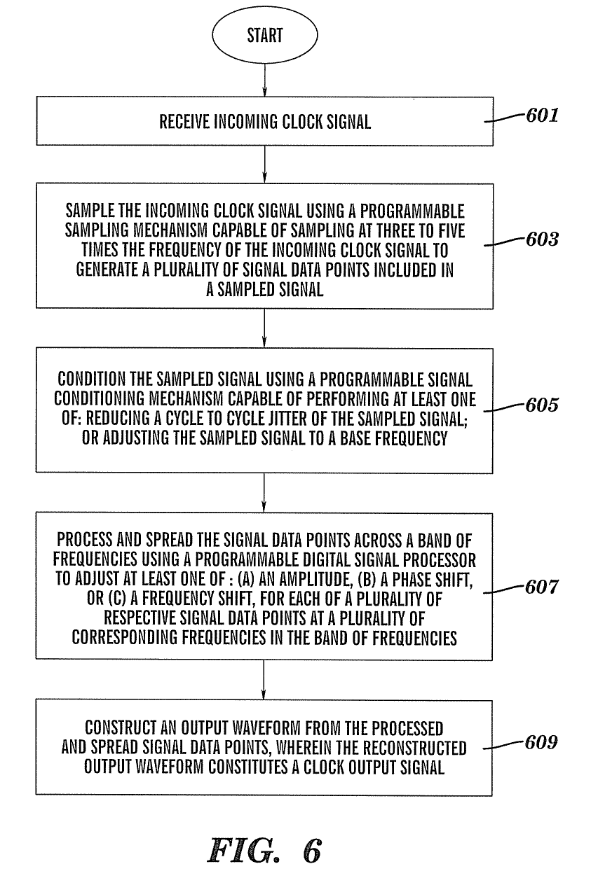

FIG. 6 is a flowchart setting forth illustrative methods for generating a spread spectrum clock signal according to various exemplary embodiments of the invention disclosed herein. The method commences at block 601 where an incoming clock signal is received. Next, at block 603, the incoming clock signal is sampled using a programmable sampling mechanism capable of sampling at three to five times the frequency of the incoming clock signal to generate a plurality of signal data points included in a sampled signal.

The program advances to block 605 where the sampled signal is conditioned using a programmable signal conditioning mechanism capable of performing at least one of: reducing a cycle to cycle jitter of the sampled signal; or adjusting the sampled signal to a base frequency. At block 607, the signal data points are processed and spread across a band of frequencies using a programmable digital signal processor to adjust at least one of: (a) an amplitude, (b) a phase shift, or (c) a frequency shift; for each of a plurality of respective signal data points at a plurality of corresponding frequencies in the band of frequencies. Next, at block 609, an output waveform is constructed from the processed and spread signal data points, wherein the output waveform constitutes a clock output signal.

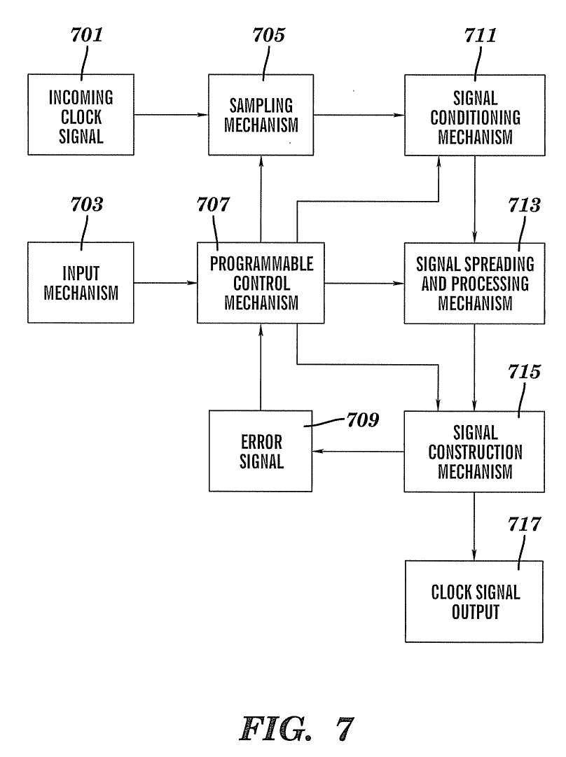

FIG. 7 is a hardware block diagram setting forth an illustrative system for generating a spread spectrum clock signal according to various exemplary embodiments of the invention disclosed herein. The system includes a programmable sampling mechanism 705 for receiving an incoming clock signal 701. The programmable sampling mechanism 705 samples the incoming clock signal 701 at three to five times the frequency of the incoming clock signal to generate a plurality of signal data points included in a sampled signal. The programmable sampling mechanism 705 is operatively coupled to a programmable signal conditioning mechanism 711 for conditioning the sampled signal by performing at least one of: reducing a cycle to cycle jitter of the sampled signal; or adjusting the sampled signal to a base frequency.

The programmable signal conditioning mechanism 711 is operatively coupled to a programmable digital signal spreading and processing mechanism 713 for processing the signal data points and spreading the signal data points across a band of frequencies by adjusting at least one of: (a) an amplitude, (b) a phase shift, or (c) a frequency shift; for each of a plurality of respective signal data points at a plurality of corresponding frequencies in the band of frequencies. The programmable digital signal spreading and processing mechanism 713 is operatively coupled to a signal construction mechanism 715 for constructing an output waveform from the processed and spread signal data points, wherein the output waveform constitutes a clock output signal 717.

The sampling mechanism 705, the signal conditioning mechanism 711, the signal spreading and processing mechanism 713, and the signal construction mechanism 715 are programmed and controlled by a programmable control mechanism 707. The programmable control mechanism 707 may include a processing mechanism, such as a microprocessor or central processing unit, operatively coupled to a computer readable storage medium such as a data storage drive, random access memory, read only memory, electronic memory, optical memory device, magnetic memory device, or other type of data storage device. The computer readable storage medium has stored therein data representing sequences of instructions which, when executed, cause the methods of FIG. 6 to be performed.

The signal construction mechanism 715 (FIG. 7) generates an error signal 709 that is sent to the programmable control mechanism 707. The programmable control mechanism uses the error signal 709 to control the operation of any of sampling mechanism 705, signal conditioning mechanism 711, signal spreading and processing mechanism 713, or signal construction mechanism 715. An input mechanism 703 may be employed to input one or more parameters into programmable control mechanism 707. The input mechanism 703 may include a keyboard, a mouse, a trackball, a USB port, a printer port, a CD-ROM drive, a floppy disk drive, or any other device capable of inputting data to the programmable control mechanism 711.

The programmable control mechanism 707 includes computer executable programmed instructions for directing the sampling mechanism 705, the signal conditioning mechanism 711, the signal spreading and processing mechanism 713, and the signal construction mechanism 715 to implement any of the embodiments of the present invention. The programmed instructions may be embodied in at least one hardware, firmware, or software module resident in the computer readable storage medium of the programmable control mechanism 707. Alternatively or additionally, the programmed instructions may be embodied on a computer readable medium (such as a CD disk or floppy disk) which may be used for transporting the programmed instructions to the programmable control mechanism 707 via the input mechanism 703 such as a CD-ROM drive or floppy disk drive. Alternatively or additionally, the programmed instructions may be embedded in a computer-readable, signal or signal-bearing medium that is uploaded to a network by a vendor or supplier of the programmed instructions, and this signal or signal-bearing medium may be downloaded through an input mechanism 703 to the programmable control mechanism 707 from the network by end users or potential buyers.

Although FIG. 7 shows separate elements for the sampling mechanism 705, the signal conditioning mechanism 711, the signal spreading and processing mechanism 713 and the signal reconstruction mechanism 715, this is only for illustrative purposes. Two or more of these elements could be combined into and implemented by a single hardware element such as a microprocessor, central processing unit, or the like. Moreover, it is to be clearly understood that the configuration of FIG. 7 is illustrative in nature, as other systems, devices, or apparatuses not shown in FIG. 7 may also be used to implement embodiments of the invention. The programmable control mechanism 707 may contain additional software and hardware, a description of which is not necessary for understanding the invention.

The spread spectrum configuration of FIG. 7 offers many advantages over prior art approaches. One advantage is programmability. The programmable control mechanism 707 allows a user to program the configuration of FIG. 7 to meet the needs of a wide variety of system applications. For example, the input mechanism 703 can receive an amount of spread as specified by a user, whereupon the programmable control mechanism 707 can implement the specified amount of spread without the necessity of ordering a new set of hardware components to provide the spread. Moreover, the amount of spread can be changed to meet system demands on the fly. During heavy load times, a software application could push the threshold of maximum spread that the device allows. Then, during non-heavy processing times, the spread can be turned down (adjusted to a lesser value) to be safely within a desired tolerance. The configuration of FIG. 7 can be implemented wherever spread spectrum may be useful in ensuring compliance with EMI standards.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing spread spectrum using digital signal processing techniques, the method including:
receiving an incoming clock signal having a clock signal frequency;
sampling the incoming clock signal using a programmable sampling mechanism to generate a plurality of signal data points included in a sampled signal;
conditioning the sampled signal using a programmable signal conditioning mechanism;
processing and spreading the signal data points across a band of frequencies using a programmable digital signal processor; and
constructing an output waveform from the processed and spread signal data points, wherein the output waveform constitutes a clock output signal.

2. The method of claim 1 wherein the incoming clock signal is sampled at three to five times the clock signal frequency.

3. The method of claim 1 wherein the sampled signal is conditioned by reducing a cycle to cycle jitter of the sampled signal.

4. The method of claim 1 wherein the sampled signal is conditioned by adjusting the sampled signal to a base frequency.

5. The method of claim 1 wherein the processing and spreading adjusts an amplitude for each of a plurality of respective signal data points at a plurality of frequencies in the band of frequencies.

6. The method of claim 1 wherein the processing and spreading adjusts a phase shift for each of a plurality of respective signal data points at a plurality of frequencies in the band of frequencies.

7. The method of claim 1 wherein the processing and spreading adjusts a frequency shift for each of a plurality of respective signal data points at a plurality of frequencies in the band of frequencies.

8. A computer program product for implementing spread spectrum using digital signal processing techniques, the computer program product including a storage medium readable by a processing circuit and storing instructions for execution by the processing circuit for facilitating a method including:
receiving an incoming clock signal having a clock signal frequency;
sampling the incoming clock signal using a programmable sampling mechanism to generate a plurality of signal data points included in a sampled signal;
conditioning the sampled signal using a programmable signal conditioning mechanism;
processing and spreading the signal data points across a band of frequencies using a programmable digital signal processor; and
constructing an output waveform from the processed and spread signal data points, wherein the output waveform constitutes a clock output signal.

9. The computer program product of claim 8 wherein the incoming clock signal is sampled at three to five times the clock signal frequency.

10. The computer program product of claim 8 wherein the sampled signal is conditioned by reducing a cycle to cycle jitter of the sampled signal.

11. The computer program product of claim 8 wherein the sampled signal is conditioned by adjusting the sampled signal to a base frequency.

12. The computer program product of claim 8 wherein the processing and spreading adjusts an amplitude for each of a plurality of respective signal data points at a plurality of frequencies in the band of frequencies.

13. The computer program product of claim 8 wherein the processing and spreading adjusts a phase shift for each of a plurality of respective signal data points at a plurality of frequencies in the band of frequencies.

14. The computer program product of claim 8 wherein the processing and spreading adjusts a frequency shift for each of a plurality of respective signal data points at a plurality of frequencies in the band of frequencies.

15. A system for implementing spread spectrum using digital signal processing techniques, the system including:
a programmable sampling mechanism for receiving an incoming clock signal and for sampling the incoming clock signal to generate a plurality of signal data points included in a sampled signal;
a programmable signal conditioning mechanism, operatively coupled to the programmable sampling mechanism, for conditioning the sampled signal;
a programmable digital signal processor, operatively coupled to the programmable signal conditioning mechanism, for processing the signal data points and spreading the signal data points across a band of frequencies;
a signal construction mechanism, operatively coupled to the programmable digital signal processor, for constructing an output waveform from the processed and spread signal data points, wherein the output waveform constitutes a clock output signal.

16. The system of claim 15 wherein the programmable sampling mechanism is capable of sampling the incoming clock signal at three to five times the clock signal frequency.

17. The system of claim 15 wherein the programmable signal conditioning mechanism conditions the sampled signal by reducing a cycle to cycle jitter of the sampled signal.

18. The system of claim 15 wherein the programmable signal conditioning mechanism conditions the sampled signal by adjusting the sampled signal to a base frequency.

19. The system of claim 15 wherein the programmable digital signal processor processes and spreads the signal data points by adjusting an amplitude for each of a plurality of respective signal data points at a plurality of frequencies in the band of frequencies.

20. The system of claim 15 wherein the programmable digital signal processor processes and spreads the signal data points by adjusting a phase shift for each of a plurality of respective signal data points at a plurality of frequencies in the band of frequencies.

21. The system of claim 15 wherein the programmable digital signal processor processes and spreads the signal data points by adjusting a frequency shift for each of a plurality of respective signal data points at a plurality of frequencies in the band of frequencies.
